(19) United States
(12) Patent Application Publication
(10) Pub. No.: US 2026/0280701 A1
(43) Pub. Date: Sep. 17, 2026

(54) POLARIZATION STATE MONITORING APPARATUS, POLARIZATION STATE MONITORING METHOD, AND NON-TRANSITORY COMPUTER-READABLE MEDIUM

(71) Applicant: NEC CORPORATION, Tokyo (JP)

(72) Inventor: Mingqi WU, Tokyo (JP)

(73) Assignee: NEC CORPORATION, Tokyo (JP)

(21) Appl. No.: 19/473,825

(22) PCT Filed: Apr. 27, 2023
(86) PCT No.: PCT/JP2023/016756

§ 371 Date: Oct. 9, 2025

(51) Int. Cl. H04B 10/079; G01J 4/04

(52) U.S. Cl. CPC H04B 10/0795; G01J 4/04; H04B 10/0799

(57) ABSTRACT

A polarization state monitoring apparatus acquires a sample data sequence. The sample data sequence indicates, for each of a plurality of frames of an optical reception signal, sample data representing the polarization state. The polarization state monitoring apparatus maps each of the plurality of pieces of sample data to a corresponding point in a Stokes space, and calculates a plane that fits the plurality of corresponding points. The polarization state monitoring apparatus detects an abnormality in the polarization state of the optical reception signal by using the calculated plane.

### TECHNICAL FIELD

The present disclosure relates to a polarization state monitoring apparatus, a polarization state monitoring method, and a non-transitory computer-readable medium.

### BACKGROUND ART

In an optical communication system, a technique for monitoring a change in a polarization state of an optical signal has been developed. For example, NPL 1 discloses a technique for monitoring a change in a polarization state of an optical reception signal modulated by quadrature phase-shift keying (QPSK). The system of NPL 1 calculates a plurality of Jones vectors from the optical reception signal, and maps each calculated Jones vector to a point in the Stokes space. Next, the system of NPL 1 divides a plurality of mapped points thus obtained into four groups and calculates a center point for each group.

Furthermore, the system of NPL 1 calculates a normal vector based on the calculated four center points. The system of NPL 1 monitors changes in the optical reception signal based on changes in the normal vector calculated in this manner.

### CITATION LIST

### Non Patent Literature

NPL 1: Jingnan Li, Yangyang Fan, Zhenning Tao, Hisao Nakashima, and Takeshi Hoshida, “Polarization Change Monitor Based on Geometrical Analysis in Stokes Space”, 2021 European Conference on Optical Communication (ECOC), Nov. 22, 2021, pp. 1-4
NPL 2: Bogdan Szafraniec, Todd S. Marshall, and Bernd Nebendahl, “Performance Monitoring and Measurement Techniques for Coherent Optical Systems”, Journal of Lightwave Technology, Feb. 15, 2013, vol. 31, no. 4, pp. 648-663.

### SUMMARY OF INVENTION

### Technical Problem

In NPL 1, it is assumed that QPSK is used as the modulation method. The present disclosure has been made in view of this problem, and an object of the present disclosure is to provide a new technique for monitoring a polarization state of an optical reception signal.

### Solution to Problem

A polarization state monitoring apparatus of the present disclosure includes: an acquisition means for acquiring sample data indicating a polarization state for each of a plurality of frames of an optical reception signal; a mapping means for mapping each of the plurality of pieces of sample data to a corresponding point in the Stokes space; a plane calculation means for calculating a plane fitted to the corresponding points; and a detection means for detecting an abnormality in the polarization state of the optical reception signal using the calculated plane.

A protective body control method of the present disclosure is executed by a computer. The method includes: an acquisition step of acquiring sample data indicating a polarization state for each of a plurality of frames of an optical reception signal; a mapping step of mapping each of the plurality of pieces of sample data to a corresponding point in the Stokes space; a plane calculation step of calculating a plane fitted to the corresponding points; and a detection step of detecting an abnormality in the polarization state of the optical reception signal using the calculated plane.

According to the present disclosure, a non-transitory computer-readable medium stores a program for causing a computer to execute the polarization state monitoring method of the present disclosure.

### Advantageous Effects of Invention

According to the present disclosure, a new technique for monitoring the polarization state of an optical reception signal is provided.

### BRIEF DESCRIPTION OF DRAWINGS

FIG. 1 is a diagram illustrating an overview of an operation of a polarization state monitoring apparatus according to a first example embodiment.

FIG. 2 is a block diagram illustrating a functional configuration of the polarization state monitoring apparatus in the first example embodiment.

FIG. 3 is a block diagram illustrating a hardware configuration of a computer that implements the polarization state monitoring apparatus.

FIG. 4 is a flowchart illustrating a flow of processing performed by the polarization state monitoring apparatus in the first example embodiment.

FIG. 5 is a diagram conceptually illustrating a state in which the sample data sequence is generated from the optical reception signal.

### EXAMPLE EMBODIMENTS

Hereinafter, example embodiments of the present disclosure will be described in detail with reference to the drawings. In the drawings, the same or related elements are denoted by the same reference numerals, and repeated description is omitted as necessary for clarity of description. Unless otherwise described, predetermined values such as predetermined values or threshold values are stored in advance in a storage device or the like accessible from an apparatus using the values. Furthermore, unless otherwise described, the storage unit includes one or more storage devices of any number.

### First Example Embodiment

### <Overview>

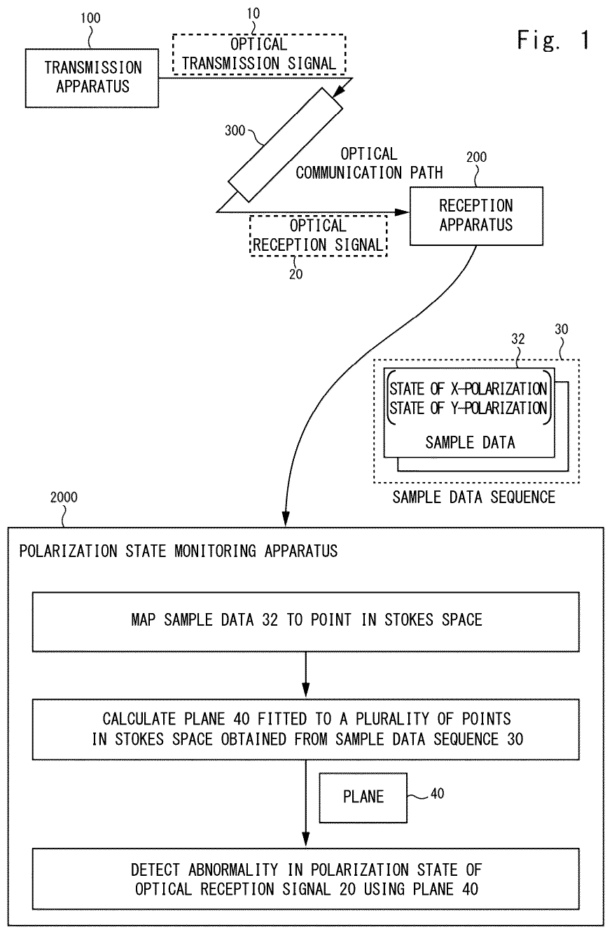

FIG. 1 is a diagram illustrating an overview of an operation of a polarization state monitoring apparatus 2000 according to a first example embodiment. Here, FIG. 1 is a diagram for facilitating understanding of the outline of the polarization state monitoring apparatus 2000, and the operation of the polarization state monitoring apparatus 2000 is not limited to that illustrated in FIG. 1.

The polarization state monitoring apparatus 2000 detects an abnormality in the polarization state of the optical signal received by a reception apparatus 200. The optical reception apparatus 200 receives an optical signal transmitted from a transmission apparatus 100 via an optical communication path 300. The optical communication path 300 is a communication path capable of transmitting an optical signal, and is configured using, for example, an optical fiber. Here, the optical signal transmitted from the transmission apparatus 100 and the optical signal received by the reception apparatus 200 are referred to as an optical transmission signal 10 and an optical reception signal 20, respectively.

Communication between the transmission apparatus 100 and the reception apparatus 200 is performed as follows, for example. The transmission apparatus 100 generates the optical transmission signal 10 from data (hereinafter, message) to be transmitted to the reception apparatus 200. Specifically, the transmission apparatus 100 generates a symbol sequence by dividing the message into a plurality of frames and encoding data of each frame into a symbol. Then, the transmission apparatus 100 generates the polarization-multiplexed optical transmission signal 10 by modulating the X-polarization and the Y-polarization of the optical carrier wave based on the symbol sequence.

The reception apparatus 200 recovers the message from the optical reception signal 20. To achieve this, the reception apparatus 200 converts the optical reception signal 20 into a digital signal. Further, the reception apparatus 200 obtains a symbol sequence by dividing the digital signal into a plurality of frames and converting each frame into a symbol. Then, the reception apparatus 200 obtains the message by decoding each symbol of the symbol sequence.

The polarization state monitoring apparatus 2000 operates as follows, for example, to detect an abnormality in the polarization state of the optical reception signal 20. First, the polarization state monitoring apparatus 2000 acquires a sample data sequence 30. The sample data sequence 30 is time-series data of a plurality of pieces of sample data 32. The sample data 32 indicates the state of the X-polarization and the state of the Y-polarization of the optical reception signal 20. An example of data that can indicate the state of the X-polarization and the state of the Y-polarization of the optical signal is Jones vector. The sample data 32 is obtained for each of the frames of the optical reception signal 20.

The polarization state monitoring apparatus 2000 maps each sample data 32 included in the sample data sequence 30 to a point in the Stokes space. Hereinafter, a point in the Stokes space corresponding to the sample data 32 is referred to as a corresponding point of the sample data 32. In addition, a set of corresponding points obtained from respective pieces of sample data 32 included in the sample data sequence 30 is referred to as a corresponding point cloud.

The polarization state monitoring apparatus 2000 calculates a plane 40 in the Stokes space that fits a plurality of corresponding points (that is, a corresponding point cloud) obtained from the sample data sequence 30. Then, the polarization state monitoring apparatus 2000 detects an abnormality in the polarization state of the optical reception signal 20 based on the plane 40.

For example, the polarization state monitoring apparatus 2000 acquires a plurality of sample data sequences 30 and calculates the plane 40 for each sample data sequence 30. As a result, time-series data of the plane 40 is obtained. The polarization state monitoring apparatus 2000 detects an abnormality in the polarization state of the optical reception signal 20 by monitoring the temporal change of the plane 40 using the time-series data of the plane 40.

### <Example of Operation and Effect>

The polarization state monitoring apparatus 2000 of the present example embodiment maps each of the plurality of pieces of sample data 32 to a corresponding point in the Stokes space, calculates a plane fitted to the plurality of corresponding points obtained by the mapping, and detects an abnormality in the polarization state of the optical reception signal 20 using the plane. As described above, according to the present disclosure, a new technique for monitoring the polarization state of an optical reception signal is provided.

In addition, the process of “mapping data representing a polarization state such as Jones vector onto the Stokes space, and calculating a plane fitted to the plurality of points obtained by the mapping” can be executed regardless of the modulation scheme. Therefore, according to the polarization state monitoring apparatus 2000, the polarization state of the optical reception signal can be monitored regardless of the modulation scheme.

Hereinafter, the polarization state monitoring apparatus 2000 in the present example embodiment will be described in more detail.

### <Example of Functional Configuration>

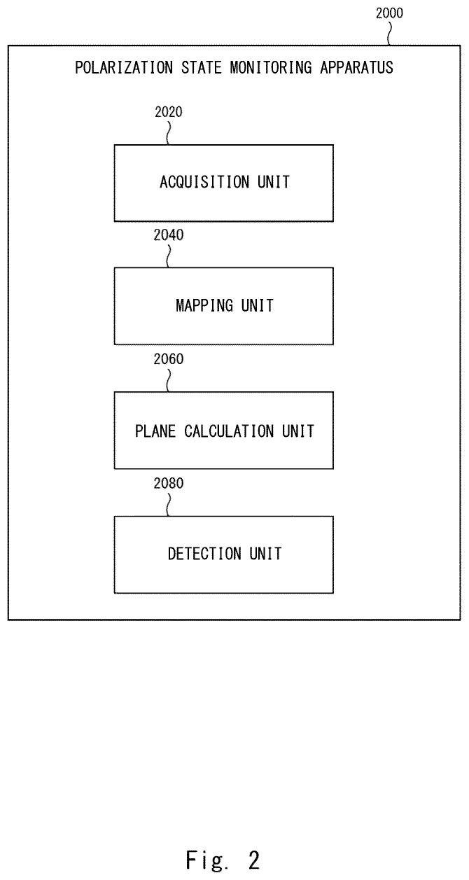

FIG. 2 is a block diagram illustrating a functional configuration of the polarization state monitoring apparatus 2000 in the first example embodiment. The polarization state monitoring apparatus 2000 includes an acquisition unit 2020, a mapping unit 2040, a plane calculation unit 2060, and a detection unit 2080. The acquisition unit 2020 acquires the sample data sequence 30 obtained from the optical reception signal 20. The mapping unit 2040 maps each sample data 32 included in the sample data sequence 30 to a point in the Stokes space, thereby generating a corresponding point cloud. The plane calculation unit 2060 calculates the plane 40 in the Stokes space that fits the corresponding point cloud obtained from the sample data sequence 30. The detection unit 2080 detects an abnormality in the polarization state of the optical reception signal 20 using the plane 40.

### <Example of Hardware Configuration>

Each functional configuration unit of the polarization state monitoring apparatus 2000 may be implemented by hardware (for example, a hard-wired electronic circuit or the like) that implements each functional configuration unit, or may be implemented by a combination of hardware and software (for example, a combination of an electronic circuit and a program that controls the electronic circuit or the like). Hereinafter, a case where each functional configuration unit of the polarization state monitoring apparatus 2000 is achieved by a combination of hardware and software will be further described.

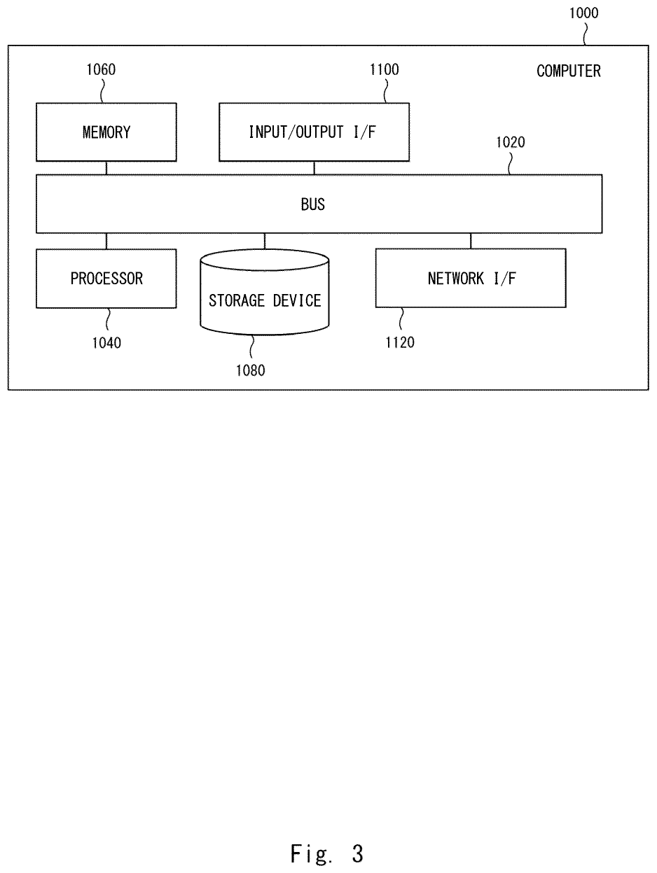

FIG. 3 is a block diagram illustrating a hardware configuration of a computer 1000 that implements the polarization state monitoring apparatus 2000. The computer 1000 is any computer. For example, the computer 1000 is a stationary computer such as a personal computer (PC) or a server machine. In another example, the computer 1000 is a portable computer such as a smartphone or a tablet terminal. In yet another example, the computer 1000 is a semiconductor chip such as a system on chip (SoC). The computer 1000 may be a dedicated computer designed to implement the polarization state monitoring apparatus 2000, or may be a general-purpose computer.

For example, when a predetermined application is installed in the computer 1000, each function of the polarization state monitoring apparatus 2000 is implemented in the computer 1000. The above-described application is configured with a program for implementing the functional configuration units of the polarization state monitoring apparatus 2000. The method of acquiring the program is arbitrary. For example, the program can be acquired from a storage medium (a DVD disk, a USB memory, or the like) in which the program is stored.

In addition, for example, the program can be acquired by downloading the program from a server apparatus that manages a storage device in which the program is stored.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, a method of connecting the processor 1040 and the like to each other is not limited to the bus connection.

The processor 1040 is various processors such as a central processing unit (CPU), a graphics processing unit (GPU), a digital signal processor (DSP), or a field-programmable gate array (FPGA). The memory 1060 is a main storage device achieved by using a random-access memory (RAM) or the like. The storage device 1080 is a secondary storage device implemented by using a hard disk, a solid state drive (SSD), a memory card, read only memory (ROM), or the like.

The input/output interface 1100 is an interface connecting the computer 1000 with an input/output device. For example, an input device such as a keyboard and an output device such as a display device are connected to the input/output interface 1100.

The network interface 1120 is an interface connecting the computer 1000 to a network. The network may be a Local Area Network (LAN) or a Wide Area Network (WAN).

The storage device 1080 stores a program (program for implementing the above-described application) for implementing each functional configuration unit of the polarization state monitoring apparatus 2000. The processor 1040 implements each functional configuration unit of the polarization state monitoring apparatus 2000 by reading and executing this program in the memory 1060.

The polarization state monitoring apparatus 2000 may be implemented by one computer 1000 or may be implemented by a plurality of computers 1000. In the latter case, the configurations of the computers 1000 do not need to be the same, and can be different from each other.

The polarization state monitoring apparatus 2000 may be implemented integrally with the reception apparatus 200. In this case, each functional component of the polarization state monitoring apparatus 2000 is mounted inside the reception apparatus 200. As a result, the reception apparatus 200 also functions as the polarization state monitoring apparatus 2000.

### <Flow of Processing>

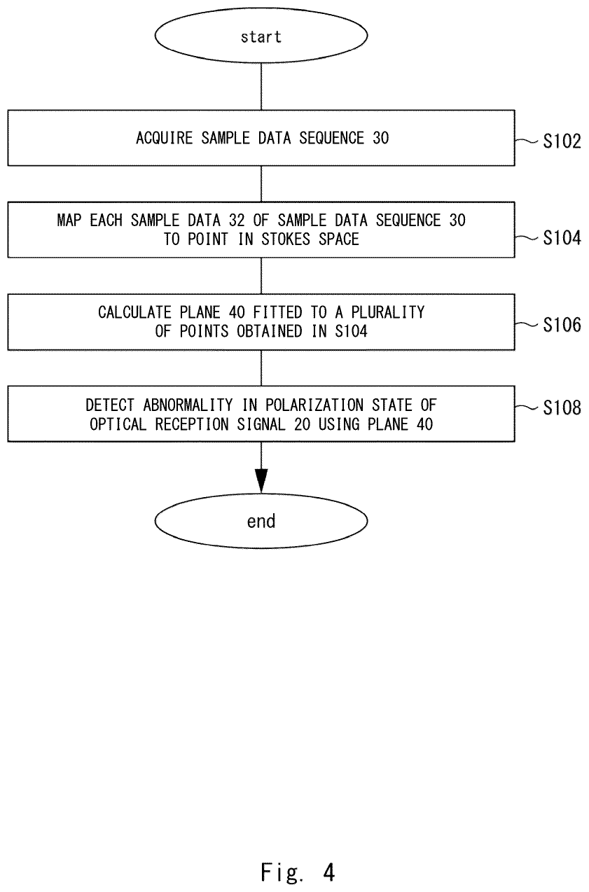

FIG. 4 is a flowchart illustrating a flow of processing performed by the polarization state monitoring apparatus 2000 in the first example embodiment. The processing of FIG. 4 is executed for each sample data sequence 30 obtained from the optical reception signal 20.

The acquisition unit 2020 acquires the sample data sequence 30 (S102). The mapping unit 2040 maps each sample data 32 included in the sample data sequence 30 to a point in the Stokes space (S104). The plane calculation unit 2060 calculates a plane 40 that fits the corresponding point cloud obtained by the mapping in S104 (S106). The detection unit 2080 detects an abnormality in the polarization state of the optical reception signal 20 based on the one or more planes 40 calculated so far (S108).

### <Sample Data Sequence 30>

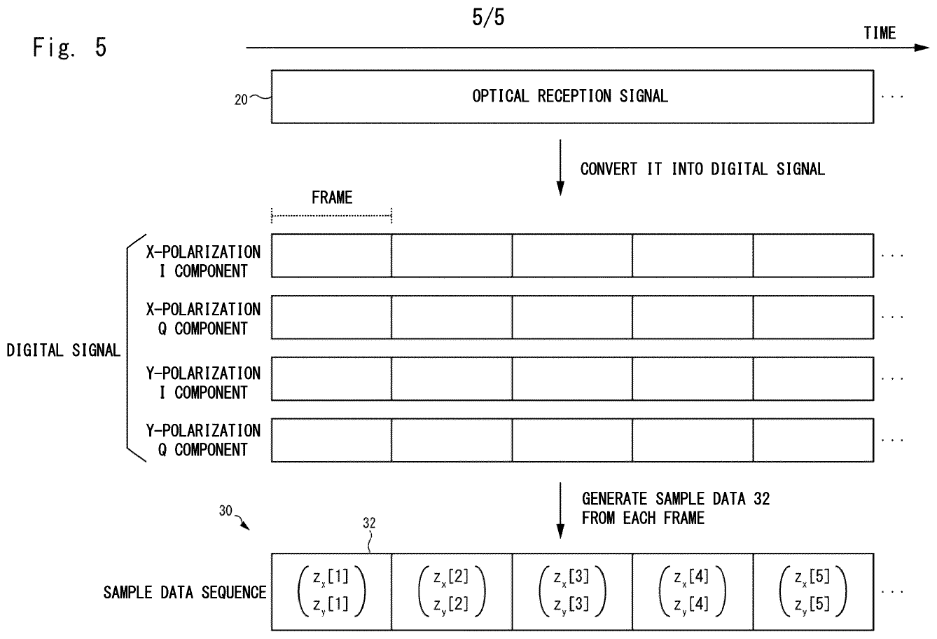

The sample data 32 is generated from each frame obtained from the optical transmission signal 10. FIG. 5 is a diagram conceptually illustrating a state in which the sample data sequence 30 is generated from the optical reception signal 20. The reception apparatus 200 converts the optical reception signal 20 into a digital signal. Here, the digital signal is obtained for each of the I and Q components of the X-polarization and for each of the I and Q components of the Y-polarization.

The reception apparatus 200 divides the digital signal into frames. Further, the reception apparatus 200 generates data z_x[i] indicating the state of the X-polarization for each frame from the I and Q component digital signals of the X-polarization. Here, i is a frame number. Similarly, the reception apparatus 200 generates data z_y[i] indicating the state of the Y-polarization for each frame from the I and Q component digital signals of the Y-polarization. For example, the vector (z_x[i], z_y[i]) is a Jones vector obtained for the i-th frame.

### <Acquisition of Sample Data Sequence 30: S102>

The acquisition unit 2020 acquires the sample data sequence 30 (S102). There are various methods for the acquisition unit 2020 to acquire the sample data sequence 30. For example, the reception apparatus 200 is configured to repeatedly generate the sample data 32 from the optical reception signal 20 and transmit the sample data 32 to the polarization state monitoring apparatus 2000. In this case, the acquisition unit 2020 acquires the sample data sequence 30 by receiving the sample data 32 transmitted from the polarization state monitoring apparatus 2000. For example, it is assumed that the sample data sequence 30 includes k pieces of sample data 32. In this case, the acquisition unit 2020 generates one sample data sequence 30 every time k pieces of sample data 32 are received.

In addition, for example, the reception apparatus 200 is configured to store the sample data 32 generated from the optical reception signal 20 in a storage unit accessible from the polarization state monitoring apparatus 2000. The acquisition unit 2020 generates the sample data sequence 30 by repeatedly acquiring the sample data 32 from the storage unit.

Here, two sample data sequences 30 adjacent to each other in time series may partially overlap each other. In the former case, for example, the acquisition unit 2020 generates a plurality of sample data sequences 30 from the time-series sample data 32 obtained from the reception apparatus 200 using a sliding window. For example, it is assumed that the window size and the slide width are w and s, respectively. In this case, each sample data sequence 30 includes w pieces of sample data 32. In addition, in two sample data sequences 30 adjacent to each other in time series, (w-s) pieces of sample data 32 overlap each other.

### <Mapping of Sample Data Sequence 30: S104>

The mapping unit 2040 maps each sample data 32 included in the sample data sequence 30 to a point in the Stokes space (S104). In other words, the mapping unit 2040 calculates the corresponding point for each sample data 32 included in the sample data sequence 30.

In order to calculate the corresponding point for the sample data 32, for example, the mapping unit 2040 calculates a Stokes vector for each sample data 32. The Stokes vector S includes a list of four types of Stokes parameters s1, s2, s3, and s4. The Stokes vector S can be calculated, for example, as follows.

$$\begin{matrix}[ Math . 1 ] & \\ S [ i ] = ( \begin{matrix}{s}_{0} [ i ] \\ {s}_{1} [ i ] \\ {s}_{2} [ i ] \\ {s}_{3} [ i ]\end{matrix} ) = ( \begin{matrix}{z}_{x} [ i ] {{z}_{x} [ i ]}^{*} + {z}_{y} [ i ] {{z}_{y} [ i ]}^{*} \\ {z}_{x} [ i ] {{z}_{x} [ i ]}^{*} - {z}_{y} [ i ] {{z}_{y} [ i ]}^{*} \\ {{z}_{x} [ i ]}^{*} {z}_{y} [ i ] + {z}_{x} [ i ] {{z}_{y} [ i ]}^{*} \\ - {{jz}_{x} [ i ]}^{*} {z}_{y} [ i ] + {jz}_{x} [ i ] {{z}_{y} [ i ]}^{*}\end{matrix} ) & ( 1 )\end{matrix}$$

S[i] represents the Stokes vector S calculated for the i-th sample data 32. z_x[i] represents the x-polarization component of the i-th sample data 32. z_y[i] represents the y-polarization component of the i-th sample data 32. * represents conjugation. j represents an imaginary unit. Here, both z_x[i] and z_y[i] are complex numbers.

The Stokes space is a three-dimensional space defined by three axes of an s1 axis, an s2 axis, and an s3 axis. Therefore, a corresponding point T[i] of the i-th sample data 32 can be expressed as T[i]=(s1[i], s2[i], s3[i]) using the three Stokes parameters s1[i], s2[i], and s3[i] calculated from the sample data 32. Therefore, the mapping unit 2040 calculates the corresponding points by calculating the Stokes parameters s1, s2, and s3 for each sample data 32. Note that the mapping unit 2040 may not calculate the Stokes parameter s0.

### <Calculation of Plane 40: S106>

The plane calculation unit 2060 calculates the plane 40 fits the corresponding point cloud obtained from the sample data sequence 30 (S106). Here, the plane in the Stokes space can be expressed as follows.

$$\begin{matrix}[ Math . 2 ] & \\ A * {s}_{1} + B * {s}_{2} + C * {s}_{3} + D = 0 & ( 2 )\end{matrix}$$

A, B, C, and D are real numbers.

Accordingly, for example, the plane calculation unit 2060 calculates A, B, C, and D that satisfy Expression (2) using the corresponding point cloud of the sample data sequence 30, thereby calculating the plane 40 that fits the corresponding point cloud of the sample data sequence 30. Here, various existing techniques can be used as a technique for calculating a plane that fits a plurality of points in a three-dimensional space.

For example, the plane calculation unit 2060 substitutes each corresponding point T[i] included in the corresponding point cloud {T[i]} into Expression (2) and performs singular value decomposition (SVD). As a result, A, B, C, and D in Expression (2) are calculated, so that the plane 40 is calculated.

### <<Addition of Constraints>>

In a case where quadrature amplitude modulation (QAM) modulation is used, the corresponding point cloud is located inside the lens-shaped region obtained by combining the region defined by Expression (3) and the region defined by Expression (4).

$$\begin{matrix}[ Math . 3 ] & \\ S = \frac{1}{2} ( \begin{matrix}1 + {r}^{2} \\ 1 - {r}^{2} \\ 2 r cos φ \\ 2 r sin φ\end{matrix} ) & ( 3 )\end{matrix}$$

$$\begin{matrix}[ Math . 4 ] & \\ S = \frac{1}{2} ( \begin{matrix}{r}^{2} + 1 \\ {r}^{2} - 1 \\ 2 r cos φ \\ - 2 r sin φ\end{matrix} ) & ( 4 )\end{matrix}$$

Here, φ and r represent the phase angle and the normalized amplitude of the optical signal, respectively. In addition, φ and r satisfy 0<=φ<2π and 0<=r<=1, respectively.

A method for deriving Expression (3) is disclosed in NPL 2. In the derivation of Expression (3), the point having the maximum amplitude is selected for the H-polarization state. For the V-polarization state, all points in the unit circle on the imaginary plane are taken into consideration. This is expressed by the following Jones vector.

$$\begin{matrix}[ Math . 5 ] & \\ J = \frac{1}{\sqrt{2}} ( \begin{matrix}1 \\ {re}^{j φ}\end{matrix} ) & ( 5 )\end{matrix}$$

Expression (3) is obtained by converting the Jones vector of Expression (5) into a Stokes vector.

On the other hand, in the derivation of Expression (4), a point having the maximum amplitude is selected for the V-polarization state, and an arbitrary point in the unit circle on the imaginary plane is considered for the H-polarization state. This is expressed by the following Jones vector.

$$\begin{matrix}[ Math . 6 ] & \\ J = \frac{1}{\sqrt{2}} ( \begin{matrix}{re}^{j φ} \\ 1\end{matrix} ) & ( 6 )\end{matrix}$$

Expression (4) is obtained by converting the Jones vector of Expression (6) into a Stokes vector.

From the Expressions (3) and (4), the lens-shaped region is a point-symmetric region centered on the origin. Therefore, the plane 40 fitted to a corresponding point cloud distributed inside the lens-shaped region passes through the origin. Therefore, it can be assumed that D=0 in Expression (2).

Therefore, the plane calculation unit 2060 may calculate the plane 40 by calculating A, B, and C satisfying the following using the corresponding point cloud.

$$\begin{matrix}[ Math . 7 ] & \\ A * {s}_{1} + B * {s}_{2} + C * {s}_{3} = 0 & ( 7 )\end{matrix}$$

A, B, and C are real numbers.

Note that, also in the case of using Expression (7), similarly to the case of using Expression (2), the plane 40 can be calculated by a method such as singular value decomposition.

### <<Addition of Points Used for Fitting>>

In order to calculate the plane 40 that fits the corresponding point cloud more accurately, it is preferable that the number of points that can be used for fitting is large. Therefore, the plane calculation unit 2060 may add a point to be used for fitting based on the corresponding points obtained from the sample data sequence 30.

As described above, since the corresponding point cloud is distributed inside the lens shape that is point-symmetric about the origin, it can be said that the plane fitted to the corresponding point also fits to a point located at a position symmetric to the corresponding point about the origin. Therefore, for each corresponding point T[i] included in the corresponding point cloud, the plane calculation unit 2060 calculates a point V[i] located at a position symmetric to the corresponding point about the origin. Hereinafter, the point V[i] is referred to as an additional point obtained from the corresponding point T[i]. When the corresponding point T[i] is T[i]=(s1[i], s2[i], s3[i]), the additional point V[i] obtained from the corresponding point T[i] is V[i]=(−s1[i], −s2[i], −s3[i]).

The plane calculation unit 2060 calculates a plane fitted to the set of corresponding points {T[i]} and the set of additional points {V[i]} as the plane 40.

### <Detection of Abnormality in Polarization State: S108>

The detection unit 2080 detects an abnormality in the polarization state of the optical reception signal 20 using the plane 40 (S108). A specific description on the method will be given below.

For example, the polarization state monitoring apparatus 2000 acquires a plurality of sample data sequences 30 in time series and calculates the plane 40 for each sample data sequence 30. As a result, a plurality of planes 40 in time series are obtained.

For each plane 40, the detection unit 2080 calculates the orientation of the plane 40. For this purpose, for example, the detection unit 2080 calculates a direction vector representing a specific type of direction for each plane 40. The orientation of the plane 40 is, for example, a normal direction. In this case, the detection unit 2080 calculates the normal vector of the plane 40. When the plane 40 is represented by Expression (2) or (7), the normal vector of the plane 40 is represented by (A, B, C).

For example, the detection unit 2080 obtains a plurality of direction vectors in time series by calculating a direction vector for each plane 40. Then, the plane calculation unit 2060 calculates the angular velocity from the direction vectors adjacent to each other in time series. The angular velocity calculated from two direction vectors can be expressed as follows, for example.

$$\begin{matrix}[ Math . 8 ] & \\ ω [ j ] = \frac{θ ( n [ j ] , n [ j - 1 ] )}{t [ j ] - t [ j - 1 ]} & ( 8 )\end{matrix}$$

ω[j] is an angular velocity calculated for the j-th sample data sequence 30. n[j] is a direction vector of the plane 40 obtained from the j-th sample data sequence 30. t[j] is a time corresponding to the j-th sample data sequence 30. For example, (t[i]−t[i−1]) represents a symbol interval. θ(a, b) represents an angle formed by the two vectors a and b.

By calculating the angular velocity ω[j] for each sample data sequence 30, time-series data {ω[j]|j=2, 3, . . . } of the angular velocity can be obtained. The detection unit 2080 detects an abnormality in the polarization state of the optical reception signal 20 by analyzing the time-series data of the angular velocity.

For example, the detection unit 2080 detects an abnormality in the polarization state of the optical reception signal 20 by detecting an abnormal value from the time-series data of the angular velocity. For example, it is assumed that the detection unit 2080 detects that the p-th to q-th angular velocities are abnormal values. In this case, the detection unit 2080 determines that an abnormality has occurred between the time corresponding to the p-th sample data sequence 30 and the time corresponding to the q-th sample data sequence 30. Here, various existing techniques can be used as the technique for detecting an abnormal value from time-series data.

In addition, for example, the detection unit 2080 may calculate a statistical value (for example, an average value) of the time-series data of the angular velocity for each predetermined time width and generate time-series data of the statistical value of the angular velocity. For example, the detection unit 2080 calculates an average value of every m angular velocities. In this case, the time-series data of the statistical value of the angular velocity is the time-series data of u[k] below.

$$\begin{matrix}[ Math . 9 ] & \\ u [ k ] = \frac{1}{m} {\sum }_{1 \leq l \leq m} ω [ m * ( k - 1 ) + l ] & ( 9 )\end{matrix}$$

u[k] is the k-th value indicated by the time-series data of the statistical value of the angular velocity.

For example, the detection unit 2080 detects an abnormality in the polarization state of the optical reception signal 20 by detecting an abnormal value from the time-series data of the statistical value of the angular velocity.

### <Method for Utilizing Detection Results of Abnormality in Polarization State>

The abnormality detection of the polarization state of the optical reception signal 20 can be utilized in various methods. For example, in a case where it is found that the reception apparatus 200 has failed, a history that analyzes the polarization state of the optical reception signal 20 in the reception apparatus 200 (for example, the history of the time-series data of the angular velocity and the time-series data of the statistical value of the angular velocity described above) can be used to investigate the cause of the failure of the reception apparatus 200. For example, it is assumed that an abnormality in the polarization state of the optical reception signal 20 is detected at a certain time point before the reception apparatus 200 fails. In this case, an event such as a lightning strike that causes an abnormality in the polarization state of the optical reception signal 20 is considered to be related to the failure of the reception apparatus 200.

In addition, for example, an abnormality in the reception apparatus 200 may be predicted by monitoring the polarization state of the optical reception signal 20. For example, in a case where an abnormality occurs in the polarization state of the optical reception signal 20, there is a possibility that an abnormality occurs in the reception apparatus 200 thereafter. Therefore, for example, in a case where an abnormality in the polarization state is detected for the optical reception signal 20 received by the reception apparatus 200, a message is received from the transmission apparatus 100 using a reception apparatus other than the reception apparatus 200.

While the present invention has been particularly shown and described with reference to example embodiments thereof, the present invention is not limited to these example embodiments. It will be understood by those of ordinary skill in the art that various changes in form and details may be made therein without departing from the spirit and scope of the present disclosure as defined by the claims.

In the above-described examples, the program includes a group of instructions (or software code) for causing a computer to perform one or more functions described in the example embodiments when being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or another memory technology, a CD-ROM, a digital versatile disc (DVD), a Blu-ray (registered trademark) disk, or another optical disk storage, and a magnetic cassette, a magnetic tape, a magnetic disk storage, or another magnetic storage. The program may be transmitted on a transitory computer-readable medium or a communication medium. By way of example and not limitation, the transitory computer-readable medium or the communication medium includes electrical, optical, acoustic, or any other form of propagated signals.

Some or all of the example embodiments described above may be described as, but are not limited to, the following Supplementary Notes.

### (Supplementary Note 1)

A polarization state monitoring apparatus comprising:
an acquisition means for acquiring sample data indicating a polarization state for each of a plurality of frames of an optical reception signal;
a mapping means for mapping each of the plurality of pieces of sample data to a corresponding point in the Stokes space;
a plane calculation means for calculating a plane fitted to the corresponding points; and
a detection means for detecting an abnormality in the polarization state of the optical reception signal using the calculated plane.

### (Supplementary Note 2)

The polarization state monitoring apparatus according to supplementary note 1,
wherein the mapping means maps the sample data to the corresponding point by calculating Stokes parameters from the sample data.

### (Supplementary Note 3)

The polarization state monitoring apparatus according to supplementary note 1 or 2,
wherein the plane calculation means calculates a plane that is fitted to the corresponding points and passes through an origin.

### (Supplementary Note 4)

The polarization state monitoring apparatus according to supplementary note 1 or 2,
wherein the plane calculation means calculates, for each of the corresponding points, an additional point located at a position symmetric to the corresponding point with an origin as the center, and calculates a plane fitted to the corresponding points and the additional points.

### (Supplementary Note 5)

The polarization state monitoring apparatus according to supplementary note 1 or 2,
wherein the detection means calculates an orientation of the plane, and detects an abnormality in the polarization state of the optical reception signal based on the calculated orientation of the plane.

### (Supplementary Note 6)

The polarization state monitoring apparatus according to supplementary note 5,
wherein the acquisition means acquires a plurality of sample data sequences that are sets of the pieces of sample data,
wherein the plane calculation means calculates, for each of the sample data sequences, a plane fitted to the corresponding points obtained from the sample data sequence, and
wherein the detection means generates time-series data of angular velocity based on an orientation calculated for each of the planes, and detects an abnormality in the polarization state of the optical reception signal by detecting an abnormal value from the time-series data of angular velocity.

### (Supplementary Note 7)

A computer-implemented polarization state monitoring method comprising:
an acquisition step of acquiring sample data indicating a polarization state for each of a plurality of frames of an optical reception signal;
a mapping step of mapping each of the plurality of pieces of sample data to a corresponding point in the Stokes space;
a plane calculation step of calculating a plane fitted to the corresponding points; and
a detection step of detecting an abnormality in the polarization state of the optical reception signal using the calculated plane.

### (Supplementary Note 8)

The polarization state monitoring method according to supplementary note 7,
wherein the mapping step maps the sample data to the corresponding point by calculating Stokes parameters from the sample data.

### (Supplementary Note 9)

The polarization state monitoring method according to supplementary note 7 or 8,
wherein the plane calculation step calculates a plane that is fitted to the corresponding points and passes through an origin.

### (Supplementary Note 10)

The polarization state monitoring method according to supplementary note 7 or 8,
wherein the plane calculation step calculates, for each of the corresponding points, an additional point located at a position symmetric to the corresponding point with an origin as the center, and calculates a plane fitted to the corresponding points and the additional points.

### (Supplementary Note 11)

The polarization state monitoring method according to supplementary note 7 or 8,
wherein the detection step calculates an orientation of the plane, and detects an abnormality in the polarization state of the optical reception signal based on the calculated orientation of the plane.

### (Supplementary Note 12)

The polarization state monitoring method according to supplementary note 11,
wherein the acquisition step acquires a plurality of sample data sequences that are sets of the pieces of sample data,
wherein the plane calculation step calculates, for each of the sample data sequences, a plane fitted to the corresponding points obtained from the sample data sequence, and
wherein the detection step generates time-series data of angular velocity based on an orientation calculated for each of the planes, and detects an abnormality in the polarization state of the optical reception signal by detecting an abnormal value from the time-series data of angular velocity.

### (Supplementary Note 13)

A non-transitory computer-readable medium storing a program that causes a computer to execute:
an acquisition step of acquiring sample data indicating a polarization state for each of a plurality of frames of an optical reception signal;
a mapping step of mapping each of the plurality of pieces of sample data to a corresponding point in the Stokes space;
a plane calculation step of calculating a plane fitted to the corresponding points; and
a detection step of detecting an abnormality in the polarization state of the optical reception signal using the calculated plane.

### (Supplementary Note 14)

The medium according to supplementary note 13,
wherein the mapping step maps the sample data to the corresponding point by calculating Stokes parameters from the sample data.

### (Supplementary Note 15)

The medium according to supplementary note 13 or 14,
wherein the plane calculation step calculates a plane that is fitted to the corresponding points and passes through an origin.

### (Supplementary Note 16)

The medium according to supplementary note 13 or 14,
wherein the plane calculation step calculates, for each of the corresponding points, an additional point located at a position symmetric to the corresponding point with an origin as the center, and calculates a plane fitted to the corresponding points and the additional points.

### (Supplementary Note 17)

The medium according to supplementary note 13 or 14,
wherein the detection step calculates an orientation of the plane, and detects an abnormality in the polarization state of the optical reception signal based on the calculated orientation of the plane.

### (Supplementary Note 18)

The medium according to supplementary note 17,
wherein the acquisition step acquires a plurality of sample data sequences that are sets of the pieces of sample data,
wherein the plane calculation step calculates, for each of the sample data sequences, a plane fitted to the corresponding points obtained from the sample data sequence, and
wherein the detection step generates time-series data of angular velocity based on an orientation calculated for each of the planes, and detects an abnormality in the polarization state of the optical reception signal by detecting an abnormal value from the time-series data of angular velocity.

### REFERENCE SIGNS LIST

10 optical transmission signal
20 optical reception signal
30 sample data sequence
32 sample data
40 plane
100 transmission apparatus
200 reception apparatus
300 optical communication path
1000 computer
1020 bus
1040 processor
1060 memory
1080 storage device
1100 input/output interface
1120 network interface
2000 polarization state monitoring apparatus
2020 acquisition unit
2040 mapping unit
2060 plane calculation unit
2080 detection unit

What is claimed is:

1. A polarization state monitoring apparatus performed by one or more computers, comprising:
at least one memory that is configured to store instructions; and
at least one processor that is configured to execute the instructions to:
acquire sample data indicating a polarization state for each of a plurality of frames of an optical reception signal;
map each of the plurality of pieces of sample data to a corresponding point in the Stokes space;
calculate a plane fitted to the corresponding points; and
detect an abnormality in the polarization state of the optical reception signal using the calculated plane.

2. The polarization state monitoring apparatus according to claim 1,
wherein the mapping includes mapping the sample data to the corresponding point by calculating Stokes parameters from the sample data.

3. The polarization state monitoring apparatus according to claim 1,
wherein the calculation of the plane includes calculating a plane that is fitted to the corresponding points and passes through an origin.

4. The polarization state monitoring apparatus according to claim 1,
wherein the calculation of the plane includes: calculating, for each of the corresponding points, an additional point located at a position symmetric to the corresponding point with an origin as the center; and calculating a plane fitted to the corresponding points and the additional points.

5. The polarization state monitoring apparatus according to claim 1,
wherein the detection of the abnormality includes: calculating an orientation of the plane; and detecting an abnormality in the polarization state of the optical reception signal based on the calculated orientation of the plane.

6. The polarization state monitoring apparatus according to claim 5,
wherein the at least one processor is configured to execute the instructions further to acquire a plurality of sample data sequences that are sets of the pieces of sample data,
wherein the calculation of the plane includes calculating, for each of the sample data sequences, a plane fitted to the corresponding points obtained from the sample data sequence, and
wherein the detection of the abnormality includes: generating time-series data of angular velocity based on an orientation calculated for each of the planes; and detecting an abnormality in the polarization state of the optical reception signal by detecting an abnormal value from the time-series data of angular velocity.

7. A computer-implemented polarization state monitoring method comprising:
acquiring sample data indicating a polarization state for each of a plurality of frames of an optical reception signal;
mapping each of the plurality of pieces of sample data to a corresponding point in the Stokes space;
calculating a plane fitted to the corresponding points; and
detecting an abnormality in the polarization state of the optical reception signal using the calculated plane.

8. The polarization state monitoring method according to claim 7,
wherein the mapping includes mapping the sample data to the corresponding point by calculating Stokes parameters from the sample data.

9. The polarization state monitoring method according to claim 7,
wherein the calculation of the plane includes calculating a plane that is fitted to the corresponding points and passes through an origin.

10. The polarization state monitoring method according to claim 7,
wherein the calculation of the plane includes: calculating, for each of the corresponding points, an additional point located at a position symmetric to the corresponding point with an origin as the center; and calculating a plane fitted to the corresponding points and the additional points.

11. The polarization state monitoring method according to claim 7,
wherein the detection of the abnormality includes: calculating step calculates an orientation of the plane; and detecting an abnormality in the polarization state of the optical reception signal based on the calculated orientation of the plane.

12. The polarization state monitoring method according to claim 11,
wherein the method further includes acquiring a plurality of sample data sequences that are sets of the pieces of sample data,
wherein the calculation of the plane includes calculating, for each of the sample data sequences, a plane fitted to the corresponding points obtained from the sample data sequence, and
wherein the detection of the abnormality includes: generating time-series data of angular velocity based on an orientation calculated for each of the planes; and detecting an abnormality in the polarization state of the optical reception signal by detecting an abnormal value from the time-series data of angular velocity.

13. A non-transitory computer-readable medium storing a program that causes one or more computers to execute:
acquiring sample data indicating a polarization state for each of a plurality of frames of an optical reception signal;
mapping each of the plurality of pieces of sample data to a corresponding point in the Stokes space;
calculating a plane fitted to the corresponding points; and
detecting an abnormality in the polarization state of the optical reception signal using the calculated plane.

14. The medium according to claim 13,
wherein the mapping includes mapping the sample data to the corresponding point by calculating Stokes parameters from the sample data.

15. The medium according to claim 13,
wherein the calculation of the plane includes calculating a plane that is fitted to the corresponding points and passes through an origin.

16. The medium according to claim 13,
wherein the calculation of the plane includes: calculating, for each of the corresponding points, an additional point located at a position symmetric to the corresponding point with an origin as the center; and calculating a plane fitted to the corresponding points and the additional points.

17. The medium according to claim 13,
wherein the detection of the abnormality includes: calculating an orientation of the plane; and detecting an abnormality in the polarization state of the optical reception signal based on the calculated orientation of the plane.

18. The medium according to claim 17,
wherein the program causes the one or more computers to further execute acquiring a plurality of sample data sequences that are sets of the pieces of sample data,
wherein the calculation of the plane includes calculating, for each of the sample data sequences, a plane fitted to the corresponding points obtained from the sample data sequence, and
wherein the detection of the abnormality includes: generating time-series data of angular velocity based on an orientation calculated for each of the planes; and detecting an abnormality in the polarization state of the optical reception signal by detecting an abnormal value from the time-series data of angular velocity.
